(19) United States
(12) Patent Application Publication
(10) Pub. No.: US 2015/0199860 A1
(43) Pub. Date: Jul. 16, 2015

(54) PROXIMITY-INTERROGATIVE SMART FOB SWITCHING OF ELECTRICAL DEVICE

(71) Applicant: Double Secured, Inc., Santa Fe Springs, CA (US)

(72) Inventors: Sukki HONG, Irvine, CA (US); Yong Moo LEE, Seoul (KR)

(73) Assignee: Double Secured, Inc., Santa Fe Springs, CA (US)

(21) Appl. No.: 14/155,610

(22) Filed: Jan. 15, 2014

(51) Int. Cl. G07C 9/00

(52) U.S. Cl. CPC G07C 9/00111

(57) ABSTRACT

A smart fob for interfacing with a smart module includes: a low frequency receiver for receiving a first password and a smart module ID number in a low frequency signal; a memory for storing a registration number with which the smart fob is registered to the smart module; a smart module ID detector connected to the low frequency receiver for waking-up the smart fob if the smart module ID number in the low frequency signal matches the smart module ID number in the memory; a processor for providing a second password derived from the first password and the registration number of the smart fob; and a high frequency transmitter for transmitting the second password in a high frequency signal.

### BACKGROUND OF THE INVENTION

1. Field of the Invention

Embodiments of the invention relate to switching of an electrical device, and more particularly, to switching an electrical device in the proximity of a fob. Although the embodiments of the invention are suitable for a wide scope of applications, it is particularly suitable for activating an electric lock or for turning-on electrical power only when a specific fob is in proximity and de-activating the electric lock or turning-off electrical power when the specific fob is not in proximity.

2. Discussion of the Related Art

In general, a proximity switching system has a receiving device and a fob that can transmit a wireless signal. A fob has to be sufficiently close to the receiving device such that a wireless signal transmitted from the fob can be received by the receiving device. The range within which the receiving device can receive wireless signals of the fob is the proximity. Accordingly, an increase in the signal strength of the fob or an increase in reception capability of the receiving device will increase proximity. On the other hand, a decrease in the signal strength of the fob or a decrease in reception capability of the receiving device will decrease proximity.

The two types of wireless fobs are an active fob and a reactive fob. An active fob transmits an activation code as result of a user pushing a button on the active fob. If the active fob is in proximity while the button is pushed, then the receiving device receives the activation code from the active fob and actuates and electrical device. A reactive fob transmits an activation code in response to a predetermined wireless wake-up ping from a receiving device. Typically, the reactive fob is inherently in proximity when receiving a wireless wake-up ping from a receiving device because the strength of the wireless wake-up ping is less than the signal transmission strength of the reactive fob. Upon receiving the wireless wake-up ping from the receiving device, the reactive fob transmits an activation code and then the receiving device receives the activation code from the reactive fob and actuates an electrical device.

In the cases of both the active fob and the reactive fob, the transmitted activation code is a set code transmitted from the fobs. The transmitted activation code can be captured or recorded during the wireless signal transmissions from the fobs. Thus, the transmitted activation code can be stolen and subsequently used inappropriately with the receiving device to actuate an electrical device.

### SUMMARY OF THE INVENTION

Accordingly, embodiments of the invention are directed to proximity-interrogative fob that substantially obviates one or more of the problems due to limitations and disadvantages of the related art.

An object of embodiments of the invention is to provide a proximity-interrogative fob that is reactive to a specified receiving device.

Another object of embodiments of the invention is to provide of a proximity-interrogative fob that provides a desired coded signal to the receiving device based upon a coded signal from the receiving device.

Another object of embodiments of the invention is to provide of a proximity-interrogative fob that receives a low frequency signal from the receiving device and transmits a high frequency signal to the receiving device.

Another object of embodiments of the invention is to provide of a proximity-interrogative fob that is registered to the receiving device and transmits a high frequency coded signal to the receiving device based on the registration number of the fob and a low frequency coded signal from the receiving device.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a smart fob for interfacing with a smart module includes: a low frequency receiver for receiving a first password and a smart module ID number in a low frequency signal; a memory for storing a registration number with which the smart fob is registered to the smart module; a smart module ID detector connected to the low frequency receiver for waking-up the smart fob if the smart module ID number in the low frequency signal matches the smart module ID number in the memory; a processor for providing a second password derived from the first password and the registration number of the smart fob; and a high frequency transmitter for transmitting the second password in a high frequency signal.

In another aspect, a smart module for actuating an electrical device in response to a smart fob includes: a low frequency transmitter for transmitting a first password and a smart module ID number in a low frequency signal; an auto-polling timer controlling the length of time between transmissions of the first password and the smart module ID number; a high frequency receiver for receiving a high frequency signal including a second password; a memory for storing a registration number with which the smart fob is registered to the smart module and for storing an ID number for the smart module; a processor for decrypting the second password and determining if the second password is from the smart fob registered to the smart module; a reset timer for running a predetermined period when the processor determines the second password is from the smart fob registered to the smart module; and a directed actuator for electrical actuation of the electrical device while the reset timer runs.

In another aspect, a system for actuating an electrical device includes: a low frequency transmitter in a smart module for transmitting a first password and a smart module ID number in a low frequency signal; a low frequency receiver in a smart fob for receiving the first password and the smart module ID number in the low frequency signal; a first processor in the smart fob for providing a second password derived from the first password and a registration number with which the smart fob is registered to the smart module; a high frequency receiver in the smart module for receiving a high frequency signal including the second password; a second processor in the smart module for decrypting the second password and determining if the second password is from the smart fob registered to the smart module; a reset timer for running a predetermined period when the second processor determines a second password is from the smart fob registered to the smart module; and a directed actuator for electrical actuation of the electrical device while the reset timer runs.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is an illustration of a door lock in a wall adjacent the door and a fob according to an embodiment of the invention.

FIG. 2 is an auto-power strip and a fob according to an embodiment of the invention.

FIG. 3 is an illustration of a door lock in a door with a key pad and a fob according to an embodiment of the invention.

FIG. 4 is an illustration of a door lock in a door with a finger pad and a fob according to an embodiment of the invention.

FIG. 5 is a flow diagram of a smart module in a device interacting with smart fob to activate a relay in a device according to an embodiment of the invention.

FIG. 6 is a block diagram of a smart module in a device that either enables an input pad or activates a relay according to an embodiment of the invention.

FIG. 7 is a block diagram of a smart fob according to an embodiment of the invention.

### DETAILED DESCRIPTION OF THE PREFERRED EMBODIMENTS

Reference will now be made in detail to the preferred embodiments of the invention, examples of which are illustrated in the accompanying drawings. Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

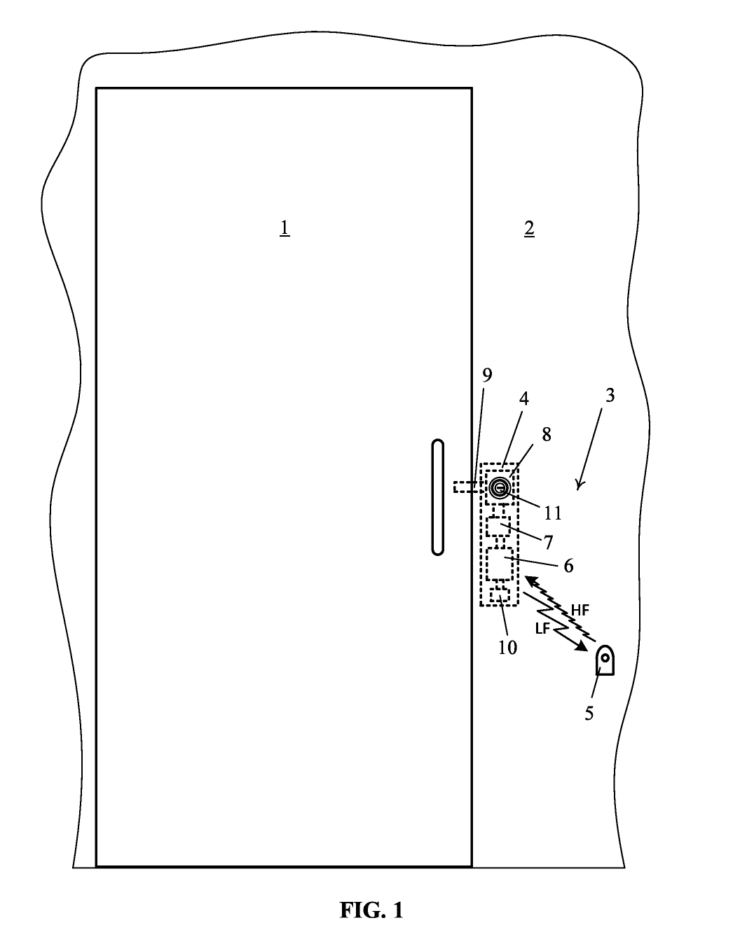

FIG. 1 is an illustration of a door lock in a wall adjacent the door and a smart fob according to an embodiment of the invention. As shown in FIG. 1, a door 1 in wall 2 is secured by a locking system 3 having a locking device 4 and a smart fob 5. The locking device 4 includes a smart module 6 connected to a relay 7 that can activate a spring loaded solenoid 8 to retract the bolt 9 from the door 1. The smart module 6 is also connected to a door sensor 10. When the smart fob 5 is in proximity to the smart module 6, the smart module 6 activates the relay 7 such that the spring-loaded solenoid 8 retracts the bolt 9. The door 1 can be opened while the bolt 9 is retracted. When the smart fob 5 is no longer in proximity to the smart module 6 and the door sensor 10 senses the door 1 is closed, the smart module 6 deactivates the relay 7 such that the spring-loaded solenoid 8 lets the bolt 9 spring back into the door 1. A mechanical lock 11 turned with a key can be used to rectract the bolt 9 in the spring-loaded solenoid 8 to override the locking system 3 or for use in the event of a power failure. Although a door is shown in FIG. 1, the locking device 4 can also be used on a safe, drawer, gate or other closure mechanisms at which restricted access is desired.

Proximity for the smart fob 5 to the smart module 6 of the locking device 4 is dependent upon three aspects. First, the smart fob 5 must be able to receive a low frequency wireless signal containing a first password from the smart module 6. Second, the smart fob 5 must be registered to the smart module 6. Third, the smart module must be able to receive a high frequency wireless signal containing a second password from the smart fob 5. Thus, proximity for the smart fob 5 to the smart module 6 is controlled by how far the smart module 6 can transmit a low frequency wireless signal containing the first password, whether the smart fob 5 is registered to the smart module 6, and how far the smart fob 5 can transmit a high frequency wireless signal containing the second password. The smart module 6 should transmit a low frequency wireless signal containing the first password at a power level such that distance within which the smart fob 5 receives the low frequency wireless signal containing is within the range of the smart fob 5 to transmit the high frequency wireless signal containing the second password to the smart module 6.

If the smart fob 5 receives the low frequency wireless signal containing the first password out of the range of the smart fob 5 to transmit the transmit the high frequency wireless signal containing the second password, then the smart fob will waste power transmitting an unreceivable high frequency wireless signal. Embodiments of the invention include a smart fob that is battery powered and a smart fob that is powered by an external power source. In the case of a battery powered smart fob, the distance of proximity should be within the transmission range of the smart fob 5 to the smart module 6 for efficient battery usage.

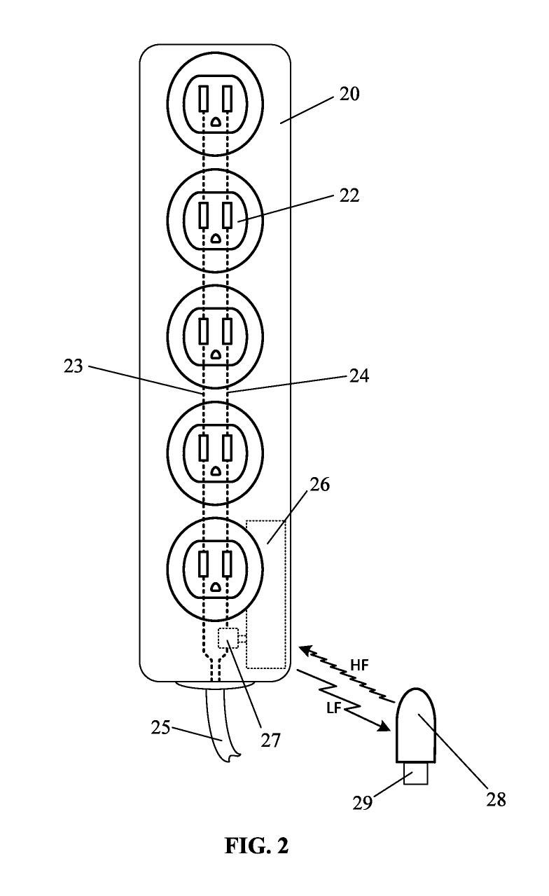

FIG. 2 is an auto-power strip and a fob according to an embodiment of the invention. As shown in FIG. 2, an auto-power strip 20 has receptacles 22 connected to a neutral wire 23 and a hot wire 24 that can receive power from the cord 25. The auto-power strip 20 also includes a smart module 26 connected to a relay 27 in the hot wire 24. When the smart fob 28 is in proximity to the smart module 26, the smart module 26 activates the relay 27 such that power can be delivered to the hot wire 24. Thus, the auto-power strip 20 is turned-on as long as the smart fob 28 is in proximity. When the smart fob 28 is no longer in proximity to the smart module 26, the relay 27 is deactivated. Although a power strip is shown in FIG. 1, auto-powering can occur for a lamp, a TV, a radio, a room, a whole house or other electrical devices/circuits at which restricted access is desired. Further, a single smart fob can activate more than one smart module or different smart fobs can activate different smart modules.

The smart fob 28 shown in FIG. 2 has a USB pin-in 29 for powering the smart fob and/or charging the battery of the smart fob 28. As discussed above, embodiments of the invention include a smart fob that is battery-powered and a smart fob that is powered by an external power source. Further, an external-powered smart fob can have an increased proximity as compared to a battery-powered smart fob since an externally-powered smart fob can have increased transmission range. For example, the distance of proximity for a battery-powered smart fob is up to 5 meters as compared to up to 15 meters for an externally-powered smart fob.

Both the smart module 6 of the locking device 4 in FIG. 1 and the smart module 26 of the auto-power strip 20 in FIG. 2 can use an external power source. Embodiments of the invention include a smart module that is battery-powered and a smart module that is powered by an external power source. A battery-powered smart module should have a transmission range as set low as practical for an intended use to conserve battery usage, such as 2 meters for a door lock. Further, a photoelectric power source such as a solar panel can be added to assist a battery-powered smart module.

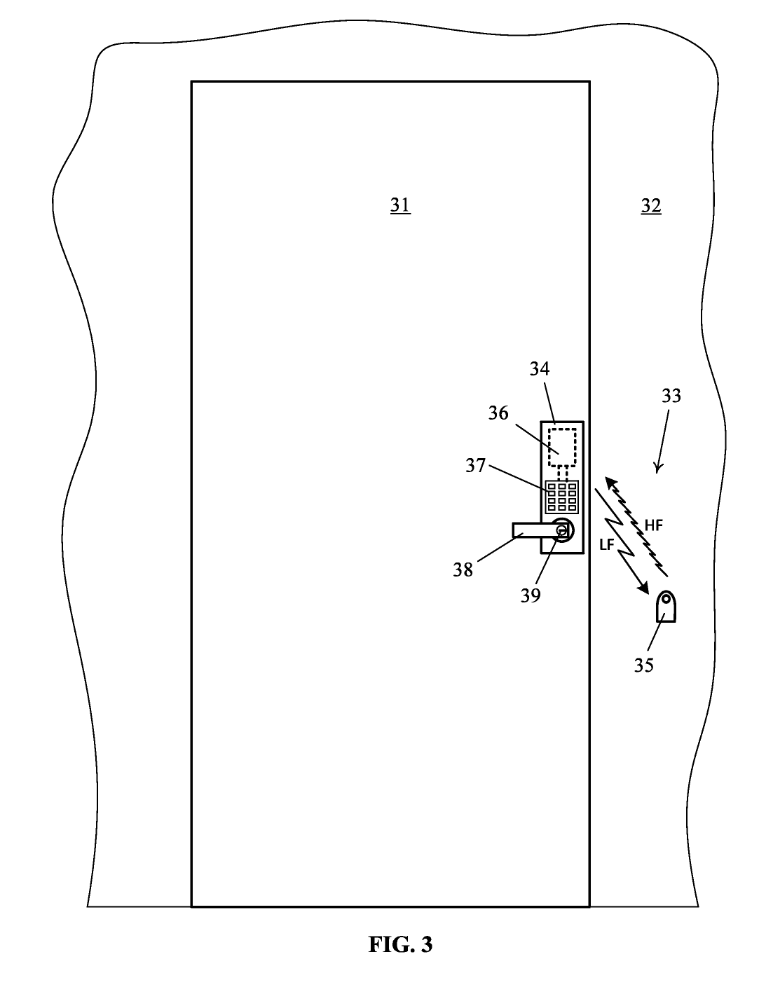

FIG. 3 is an illustration of a door lock in a door with a key pad and a fob according to an embodiment of the invention. The locking system 33 of FIG. 3 also includes that additional security feature of a key pad that requires the entry of an appropriated key code. This additional security feature prevents a stolen smart fob enabling entry.

As shown in FIG. 3, a door 31 in wall 32 is secured by a locking system 33 having a locking device 34 and a smart fob 35. The locking device 34 includes a smart module 36 connected to the key pad 37 that can enable a door handle 38 to open the door 31 when an appropriate key code is punched into the keypad 37. When the smart fob 35 is in proximity to the smart module 36, the smart module 36 activates the key pad 37 such that the key code can be entered and then the handle 38 can be turned to open the door 31. When the smart fob 35 is no longer in proximity to the smart module 36, the smart module 36 deactivates the keypad 37 such that the door handle 38 will not open the door 31. A mechanical lock 39 turned with a key can be used to open the door 31 with the handle 38 to override the locking system 33 or for use in the event of a battery failure in the smart module 34. Although a door is shown in FIG. 3, the locking device 34 can also be used on a safe, drawer, gate or other closure mechanisms at which restricted access is desired.

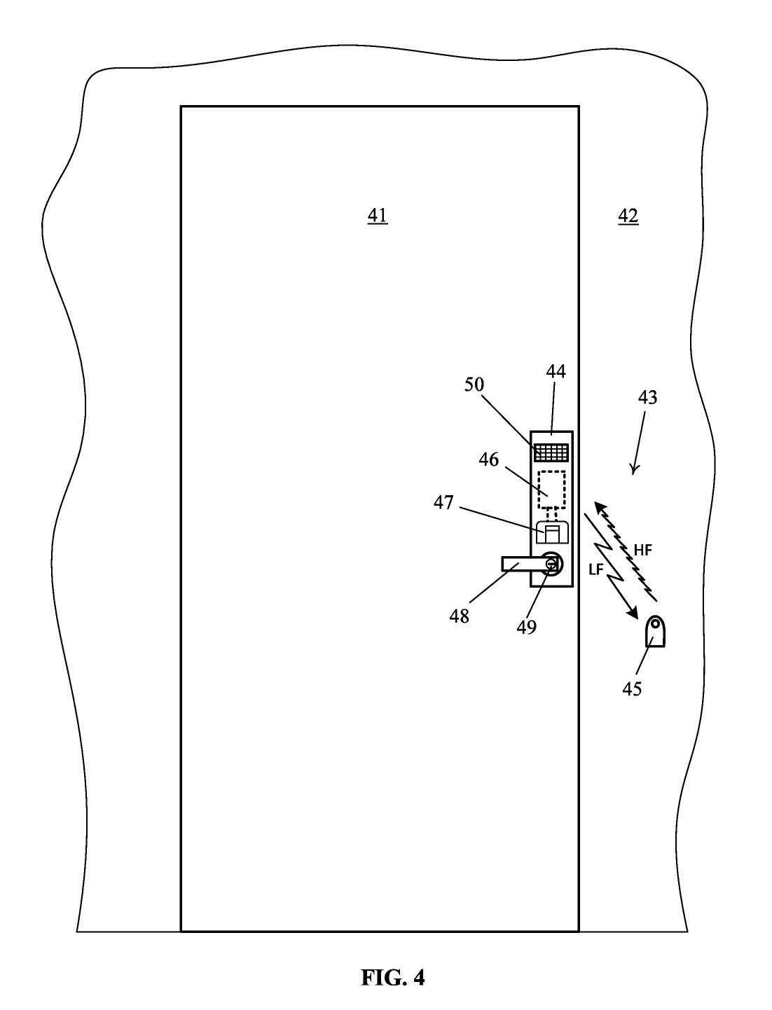

FIG. 4 is an illustration of a door lock in a door with a finger pad and a fob according to an embodiment of the invention. The locking system 43 of FIG. 4 also includes that an additional security feature of a finger print pad that requires the entry of an appropriated finger print. This additional security feature prevents a stolen smart fob enabling entry.

As shown in FIG. 4, a door 41 in wall 42 is secured by a locking system 43 having a locking device 44 and a smart fob 45. The locking device 44 includes a smart module 46 connected to a finger print pad 47 that can enable a door handle 48 to open the door 41 when an appropriate finger print is placed onto the finger print pad 47. When the smart fob 45 is in proximity to the smart module 46, the smart module 46 activates the finger print pad 47 such that a finger can be placed on the finger print pad 47 and then the handle 48 can be turned to open the door 41. When the smart fob 45 is no longer in proximity to the smart module 46, the smart module 46 deactivates the finger print pad 47 such that the door handle 48 will not open the door 41. A mechanical lock 49 turned with a key can be used to open the door 41 with the handle 48 to override the locking system 43 or for use in the event of a battery failure in the smart module 34. A solar panel 50 can be used to charge a battery within the smart module 46. Although a door is shown in FIG. 4, the locking device 44 can also be used on a safe, drawer, gate or other closure mechanisms at which restricted access is desired.

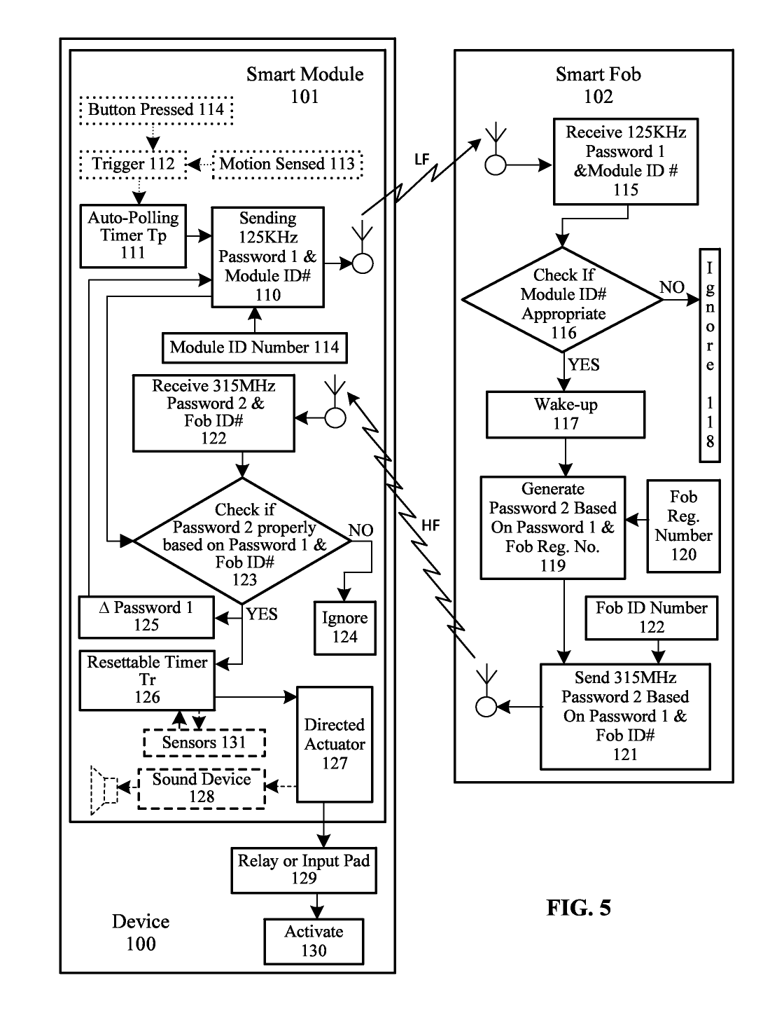

FIG. 5 is a flow diagram of a smart module in a device interacting with a smart fob to activate a relay in a device according to an embodiment of the invention. As shown in FIG. 5, a system for actuating an electrical device 100 includes a smart module 101 associated with the electrical device 100 and a smart fob. The actuation process starts with the smart module 101 sending (110) a first password and a module ID# 114 by a low frequency LF wireless transmission, such as 125 KHz, to a smart fob 102. The first password is randomly chosen and can be 16-bit, 24-bit or 32-bit. The module ID# 114 is a unique number for the smart module 101, like a serial number for that smart module 101. The module ID# 114 can be 16-bit, 24-bit or 32-bit.

The sending step (110) of the first password and the module ID# can be initiated by an auto-polling timer 111 that is constantly on or, in the alternative, a trigger 112 turns-on the auto-polling timer for a period of time in response to a triggering event, such as motion sensed 113 from a motion sensor, and/or a manual triggering, such as a button being pressed 114. The period of time that the auto-polling timer is triggered on can be the duration of the triggering event or a set time period (i.e. a timed triggering) in response to the trigger event. An auto-polling timer 111 that is constantly on controls the length of time Tp between the low frequency LF wireless transmissions. The auto-polling timer 111 that is triggered 112 also controls the length of time Tp between the low frequency LF wireless transmissions. Triggering of the auto-polling timer 111 for sending 110 the first password and the module ID# saves power compared to the auto-polling timer 111 that is constantly on.

The smart fob 102 receives 115 the low frequency LF wireless transmission containing the first password and the module ID#, as shown in FIG. 5. Then, the smart fob 102 checks 116 to see if the module ID# is the module ID# of the smart module 101 to which the smart fob 102 is registered. The smart fob 102 has a memory containing one or module ID#'s to which the smart fob 102 is registered. If the module ID# is to the smart module 101 to which the smart fob 102 is registered, then the smart fob 102 wakes-up 117. If the module ID# is to the smart module 101 to which the smart fob 102 does not recognize, then the smart fob 102 ignores 118 the low frequency LF wireless transmission containing the first password and the module ID#.

Prior to the smart fob wake-up 117, as shown in FIG. 5, the smart fob 102 is minimally powered such that only the receiving 115 and checking capability 116 of the smart fob 102 is powered up. Such a minimal power configuration conserves the battery of the smart fob 102 while maintaining the receiving 115 and checking capability 116. The smart fob 102 is only woke-up to be responsive to a smart module 101 to which the smart fob 102 is registered. The smart fob 102 ignores 118 a transmission from a smart module 101 having the module ID# not in the memory of the smart fob 102.

After the smart fob 102 is woke-up 117, a second password is generated 119 based on the first password received and the fob registration number 120. In effect, the fob registration number 120 is like a private key used to encrypt the first password into a second password. In the smart module 101, the second password is decrypted using the first password to see if the registration number 120 results. Alternatively, private key like encryption methods can be used. For example, the second password is decrypted with the fob registration number, which is associated with a fob ID#, to see if the first password results.

As shown in FIG. 5, the second password and the fob ID# 122 are sent 121 to the smart module 101 by a high frequency HF wireless transmission, such as 315 MHz. The fob ID# 122 is a unique number for the smart fob 102, like a serial number for that smart fob 102. The fob ID# 122 can be 16-bit, 24-bit or 32-bit.

The sending 121 and generating 119 processes take the most power in the smart fob 102. By checking 116 to see if the module ID# is for a smart module 101 to which the smart fob 102 is registered, battery power is conserved. The smart fob 102 can be awake and send a second password upon receipt of the first transmission of first password or, alternatively, awake on first password transmission and then send a second password upon receipt of the second transmission of first password.

As shown in FIG. 5, the smart module 101 receives 122 the high frequency HF wireless transmission containing the second password and the fob ID#. The smart module 101 has a memory containing fob ID#'s registered to the smart module as well as the fob registration numbers associated with the fob ID#'s. After receiving the second password and the fob ID# 122, the second password is then checked 123 to see if the first password was properly encrypted based on the fob registration number of the smart fob having that particular fob ID#. If the second password is not properly encrypted based on the fob registration number for the fob ID#, then the smart module 101 ignores the high frequency HF wireless transmission containing the second password and the fob ID# 124. If the second password is properly encrypted based on the fob registration number for a fob ID# of a smart fob 102 registered to the smart module 101, then the smart module 101 changes the first password 125 for the next low frequency LF wireless transmission and pulses a resettable timer 126 to start the timer.

The resettable timer 126 runs for a period of time Tr upon receiving a pulse due to a check of a second password being properly encrypted based on the fob registration number for a fob ID# 123 of a smart fob 102 registered to the smart module 101. The resettable timer 126 resets upon receipt each of subsequent pulse resulting from a check 123 that the first password was properly encrypted based on the fob registration number of a smart fob 102 registered to the smart module 101. To keep the resettable timer 126 continuously running by constantly restarting the resettable timer 126 while the smart fob 102 is in proximity to the smart module 101, the length of time Tp between the low frequency LF wireless transmissions controlled by the auto-polling timer 111 should be less than the period of time Tr for the resettable timer 126. For example, the length of time Tp for the auto-polling timer 111 is one second while the period of time Tr for the resettable timer 126 is three seconds.

As shown in FIG. 5, the resettable timer 126 enables a directed actuator 127 while the resettable timer 126 is running. The directed actuator 127 is an output buffer that provides an actuation signal with sufficient power to enable an external electrical device. For example, a relay 129 of the device 100 or an input pad 129 of the device 100 can be activated 130. In addition to relays and input pads, embodiments of the invention also include thyristors or any other type of electrical switching mechanisms to turn-on any type of electrical device.

The directed actuator 127 can turn-on sound device 128, as shown in FIG. 5, to indicate that the directed actuator 127 has been enabled. Other types of indication devices, such as a lamp can be additionally used. In the alternative, indication devices other than sound devices can be turned-on by the directed actuator 127.

When the resettable timer 126 enables the directed actuator 127, sensors 131 can also be turn-on that keep resetting the resettable timer 126 until an event is sensed. When an event is sensed, the sensors 131 no longer reset the resettable timer 126 such that the resettable timer will rundown if a registered smart fob is not in proximity.

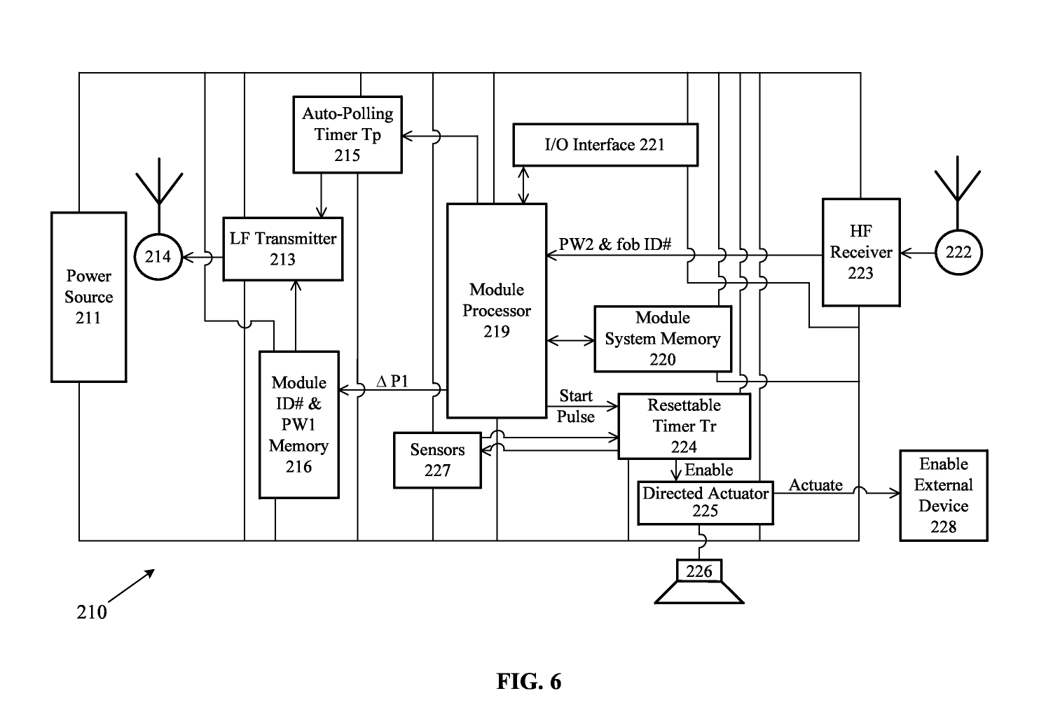

FIG. 6 is a block diagram of a smart module in a device that either enables an input pad or activates a relay according to an embodiment of the invention. As shown in FIG. 6, a smart module 210 includes a power source 211 that provides power to the components of the smart module 210. The power source 211 can be a battery, solar-assisted battery or external DC power supply.

Amongst other components, the smart module 210 in FIG. 6 includes a low frequency transmitter 213 connected to a low frequency antenna 214. A module ID# and a first password memory 216 provides the first password and the module ID# to the low frequency transmitter 213. An auto-polling timer 215 is connected to the low frequency transmitter 213 to control the length of time Tp between low frequency LF wireless transmissions, including a first password and a module ID#.

A module processor 219 is connected to the module ID# and first password memory 216, as shown in FIG. 6. The module processor 219 changes the first password in the module ID# and first password memory 216 after a use or attempted use of a previously transmitted first password. The module processor 219 randomly selects the next first password.

The module processor 219 in FIG. 6 is connected to the auto-polling timer 215. The module processor 219 can be used to set the length of time Tp between low frequency LF wireless transmissions, including a first password and a module ID#. For example, the length of time Tp for the auto-polling timer 215 can be long in a standby mode when a registered smart fob is not in proximity as opposed to an active mode when a registered smart fob is in proximity register.

As shown in FIG. 6, the module processor 219 is connected to a module system memory 220. The module processor 219 receives the decryption algorithms and other program for operation of the smart module 210 from the module system memory 220. The fob registration numbers of all registered smart fobs and the fob ID#'s respectively associated with the fob registration numbers are also stored in the module system memory 220.

An I/O interface 221 is connected to the module processor 219 in FIG. 6. The I/O interface 221 provides the capability to make changes to the smart module 210. Amongst other uses, the I/O interface 221 can be used to update the registry of fob registration numbers and fob ID#'s in the module ID# and first password memory 216. In another example, the I/O interface 221 can be used to set the length of time Tp for the auto-polling timer 215 to be longer so as to conserve power usage.

As shown in FIG. 6, a high frequency antenna 222 is connected to a high frequency receiver 223 for receiving a high frequency HF wireless transmission, including a second password and a fob ID#. The module processor 219 is connected to the high frequency receiver 223 and receives the second password and the fob ID# from the high frequency receiver 223. If the second password and the fob ID# are from a smart fob registered to the smart module 210, a start pulse is sent to the resettable timer 224, which is connected to the module processor 219.

The resettable timer 224, shown in FIG. 6, enables a directed actuator 225, which is connected to the resettable timer. The directed actuator 225 provides an actuation signal with sufficient power to enable an external electrical device 228. The directed actuator 225 can also turn-on sound device 226. When the resettable timer 224 enables the directed actuator 225, sensors 227 can also be turn-on that keep resetting the resettable timer 224 until a sensed event occurs.

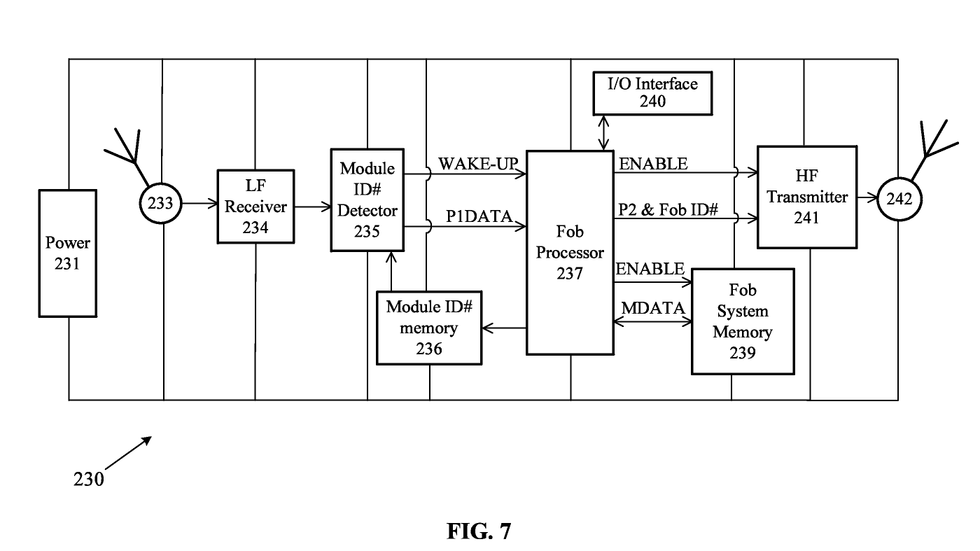

FIG. 7 is a block diagram of a smart fob according to an embodiment of the invention. As shown in FIG. 7, a smart module 230 includes a power source 231 that provides power to the components of the smart fob 230. The power source can be a battery or external DC power supply. In the case of an external DC power supply, a recharge circuit can be included that recharges the battery.

Amongst other components, the smart fob 230 in FIG. 7 includes a low frequency receiver 234 connected to a low frequency antenna 233 for receiving a module ID# and a first password. A module ID# memory 236, which contains the module ID# of the smart module 230, is connected to the module ID# detector 235. A module ID# detector 235 is connected to the low frequency receiver 234 to determine if the module ID# is in the module ID# memory 236.

As shown in FIG. 7, the fob processor 237 is connected to the module ID# detector 235. The fob processor 237 is woke-up if the module ID# is from a smart module to which the smart fob 230 is registered. When the fob processor 237 is woke-up, the fob processor 237 enables a high frequency transmitter 241 and a fob system memory 239, which are connected to the fob processor 237. The fob processor 237 receives the encryption algorithms and other programs for operation of the smart fob 230 from the fob system memory 239. The fob registration number and the fob ID# for the smart fob 230 are also stored in the fob system memory 239.

Upon the wake-up, the first password is sent by the module ID# detector 235 to the fob processor 237 to generate a second password based on the first password received and a fob registration number stored in the fob system memory 239. Then, the fob processor 237 sends the second password and the fob ID# to the high frequency transmitter 241. A high frequency antenna 242 is connected to the high frequency transmitter 241 for transmitting a high frequency HF wireless transmission, including a second password and a fob ID#.

An I/O interface 240 is connected to the fob processor 237 in FIG. 7. The I/O interface 237 provides the capability to make changes to the smart fob 230. Amongst other uses, the I/O interface 240 can be used to update the fob registration number and the fob ID# in the fob system memory 239. In another example, the I/O interface 240 can be used to update the smart module ID# to which the smart fob 230 is registered in the module ID# memory 236.

It will be apparent to those skilled in the art that various modifications and variations can be made in the embodiments of the invention without departing from the spirit or scope of the invention. Thus, it is intended that embodiments of the invention cover the modifications and variations of this invention provided they come within the scope of the appended claims and their equivalents.

What is claimed is:

1. A smart fob for interfacing with a smart module, comprising:
a low frequency receiver for receiving a first password and a smart module ID number in a low frequency signal;
a memory for storing a registration number with which the smart fob is registered to the smart module;
a smart module ID detector connected to the low frequency receiver for waking-up the smart fob if the smart module ID number in the low frequency signal matches the smart module ID number in the memory;
a processor for providing a second password derived from the first password and the registration number of the smart fob; and
a high frequency transmitter for transmitting the second password in a high frequency signal.

2. The smart fob for interfacing with a smart module according to claim 1, wherein the processor is configured to enable the high frequency transmitter.

3. The smart fob for interfacing with a smart module according to claim 1, wherein the memory includes a first memory connected to the smart module ID detector and the processor for storing the smart module ID number and a second memory connected to the processor for storing the registration number.

4. The smart fob for interfacing with a smart module according to claim 3, wherein the processor is configured to enable the second memory.

5. The smart fob for interfacing with a smart module according to claim 3, wherein the processor is configured to enable the high frequency transmitter.

6. A smart module for actuating an electrical device in response to a smart fob, comprising:
a low frequency transmitter for transmitting a first password and a smart module ID number in a low frequency signal;
an auto-polling timer controlling the length of time between transmissions of the first password and the smart module ID number;
a high frequency receiver for receiving a high frequency signal including a second password;
a memory for storing a registration number with which the smart fob is registered to the smart module and for storing an ID number for the smart module;
a processor for decrypting the second password and determining if the second password is from the smart fob registered to the smart module;
a reset timer for running a predetermined period when the processor determines the second password is from the smart fob registered to the smart module; and
a directed actuator for electrical actuation of the electrical device while the reset timer runs.

7. The smart module for actuating an electrical device in response to a smart fob according to claim 6, further comprising a triggering device for initiating the auto-polling timer for the predetermined time frame.

8. The smart module for actuating an electrical device in response to a smart fob according to claim 6, wherein the auto-polling timer is always on.

9. The smart module for actuating an electrical device in response to a smart fob according to claim 6, wherein the memory includes a first memory connected to the low frequency transmitter and the processor for storing the smart module ID number and a second memory connected to the processor for storing the registration number.

10. The smart module for actuating an electrical device in response to a smart fob according to claim 6, further comprising an indication device connected to the directed actuator for an indication while the directed actuator is actuated.

11. The smart module for actuating an electrical device in response to a smart fob according to claim 6, further comprising an I/O interface connected to the processor for enabling registration of the smart fob by inputting the registration number of the smart fob into the memory.

12. The smart module for actuating an electrical device in response to a smart fob according to claim 6, wherein the length of time between transmissions the first password and the smart module ID number in the low frequency signal controlled by the auto-polling timer is set to be less than the predetermined period of the reset timer.

13. The smart module for actuating an electrical device in response to a smart fob according to claim 12, wherein the reset timer is configured to be restarted when the processor determines another second password is from the smart fob registered to the smart module.

14. A system for actuating an electrical device, comprising:
a low frequency transmitter in a smart module for transmitting a first password and a smart module ID number in a low frequency signal;
a low frequency receiver in a smart fob for receiving the first password and the smart module ID number in the low frequency signal;
a first processor in the smart fob for providing a second password derived from the first password and a registration number with which the smart fob is registered to the smart module;
a high frequency receiver in the smart module for receiving a high frequency signal including the second password;
a second processor in the smart module for decrypting the second password and determining if the second password is from the smart fob registered to the smart module;
a reset timer for running a predetermined period when the second processor determines the second password is from a smart fob registered to the smart module; and
a directed actuator for electrical actuation of the electrical device while the reset timer runs.

15. A system for actuating an electrical device according to claim 14, wherein the second processor is configured to enable the low frequency transmitter to transmit the first password and the smart module ID number of the smart module.

16. A system for actuating an electrical device according to claim 15, further comprising;
a memory in the smart fob for storing the smart module ID number of the smart module to which the smart fob is registered; and
an ID detector in the smart fob connected to the low frequency receiver for waking-up the smart fob if the smart module ID number in the low frequency signal matches the smart module ID number in memory.

17. A system for actuating an electrical device according to claim 14, wherein the second processor is configured to enable the high frequency transmitter to transmit the second password and the smart fob ID number of the smart fob.

18. A system for actuating an electrical device according to claim 14, further comprising;
an auto-polling timer controlling the length of time between transmissions of the first password and the smart module ID number,
wherein the length of time between transmissions the first password and the smart module ID number in the low frequency signal controlled by the auto-polling timer is set to be less than the predetermined period of the reset timer.

19. A system for actuating an electrical device according to claim 18, wherein the reset timer is configured to be restarted when the processor determines another second password is from the smart fob registered to the smart module.

20. A system for actuating an electrical device according to claim 18, wherein the auto-polling timer is always on.
